(19) United States
(12) Patent Application Publication
(10) Pub. No.: US 2007/0237197 A1
(43) Pub. Date: Oct. 11, 2007

(54) Semiconductor light emitting device

(75) Inventor: Hiroshi Chikugawa, Kashihara-shi (JP)

Correspondence Address: MORRISON & FOERSTER LLP, 1650 TYSONS BOULEVARD, SUITE 400, MCLEAN, VA, 22102, US

(73) Assignee: Sharp Kabushiki Kaisha, Osaka-shi (JP)

(21) Appl. No.: 11/730,507

(22) Filed: Apr. 2, 2007

(30) Foreign Application Priority Data
Apr. 5, 2006 (JP) 2006-104481

(51) Int. Cl. H01S 3/04

(52) U.S. Cl. 372/36

(57) ABSTRACT

A semiconductor light emitting device includes a light emitting element, a heat radiating member, and a submount interposed between the light emitting element and the heat radiating member. The light emitting element is fixed to heat radiating member by a brazing material with the submount interposed. The heat radiating member has a groove on its surface to which the submount is fixed. With this configuration, a semiconductor light emitting device that is applicable to a large-sized light emitting element that is excellent in heat radiation and that has high reliability can be provided.

This nonprovisional application is based on Japanese Patent Application No. 2006-104481 filed with the Japan Patent Office on Apr. 5, 2006, the entire contents of which are hereby incorporated by reference.

### BACKGROUND OF THE INVENTION

1. Field of the Invention

The present invention relates to a semiconductor light emitting device, which is used in an illumination apparatus, a light source of a projector or the like that employs a light emitting element that primarily uses white light.

2. Description of the Background Art

A semiconductor light emitting device of the high output type that includes a large-size light emitting element, which consumes great power, requires input power of at least 5 W, and each edge of which is at least 1 mm, requires measures for heat radiation. As the measures for heat radiation, conventionally, a structure shown in FIG. 6 has generally been employed. Specifically, it is a structure in which a light emitting element 100 is fixed to a heat radiating member 102 by a brazing material 103, with a submount 101 being interposed.

Normally, when a light emitting element of about 1 mm square size is directly die-bonded on metal by a brazing material such as gold-tin alloy (AuSn) without a submount being interposed, the brazing material absorbs and reduces to some extent the stress generated due to the difference between the light emitting element and the metal in coefficient of thermal expansion. Therefore, the light emitting element hardly deteriorates.

Japanese Patent Laying-Open No. 2003-303999 discloses a technique of reducing stress by setting the coefficient of thermal expansion of a submount substrate to be the intermediate value between the coefficient of thermal expansion of a light emitting element and that of a metal core substrate. According to the technique disclosed in Japanese Patent Laying-Open No. 2003-303999, the metal core substrate is made of metal for heat radiation and divided into two for insulation.

There is also a conventional technique for absorbing stress by interposing a soft adhesive of low modulus of elasticity when arranging many light emitting elements (LEDs) on a substrate of a great area (for example, see Japanese Patent Laying-Open No. 2000-183403). Not being limited to the light emitting element, consideration has also been made as to a wire for interconnections. That is, coefficient of thermal expansion of gold (Au) that is the material of the wire and that of packaging encapsulation resin are set to approximate each other to thereby avoid peeling or disconnection of the wire (for example, see Japanese Patent Laying-Open No. 2004-172636). Furthermore, Japanese Patent No. 3712532 discloses optimization in coefficient of thermal expansion between a light emitting element and an electrode, and between the electrode and a backup member (that is a member for constraining contraction of a brazing material and the electrode, and that has coefficient of thermal expansion approximating that of the semiconductor element).

As to a light emitting element of high output and of a large size, the object of heat radiation can be attained by directly die-bonding and fixing the light emitting element to the heat radiating member made of metal using a brazing material. However, when each edge of the light emitting element exceeds 1 mm, the stress generating due to the difference in coefficient of thermal expansion between the light emitting element itself and the metal as the heat radiating member becomes not negligible. As a result, the stress cannot be reduced by the brazing material portion and invites the following problems. That is, peeling of the die-bonding portion may occur, or the light emitting element itself receives the stress and it may deteriorates quickly or be damaged.

In some cases, in order to reduce the stress on the light emitting element, ceramic (AlN), silicon carbide (SiC) or the like having substantially the same coefficient of thermal expansion as the material of the light emitting element is used as the submount. On the other hand, when each edge of the light emitting element exceeds 1 mm and reaches 3 mm to 5 mm, a larger submount is required accordingly. Therefore, the stress between the large submount and the metal that is the heat radiating member becomes extremely great. This also results in peeling of the die-bonding portion or damage between the submount and the metal heat radiating member. In order to solve such a problem, as the material of the heat radiating member, in place of metal, it may be possible to employ AlN or SiC that are used for the submount. It may also be possible to increase the size of the submount itself so that it becomes part of the package. However, because of the great expensiveness and hard workability of these materials, a problem may arise that the light emitting device becomes expensive.

Hence, there has been a problem that, when a large light emitting element is die-bonded to a heat radiating member with a submount interposed, peeling or damage is caused between the submount and the heat radiating member, due to the stress between the members attributed to thermal expansion from the heat.

### SUMMARY OF THE INVENTION

The present invention has been made to solve such problems in conventional technique. An object thereof is to provide a semiconductor light emitting device being excellent in heat radiation performance and highly reliable, which is applicable to a large-size light emitting element, which requires input power of at least 5 W and each edge of which is at least 1 mm.

In order to solve the problems, a semiconductor light emitting device of the present invention includes: a light emitting element; a heat radiating member; and a submount interposed between the light emitting element and the heat radiating member. The light emitting element is fixed to the heat radiating member by a brazing material with the submount interposed. The heat radiating member has a groove on its surface to which the submount is fixed.

Desirably, the groove is provided at least at a surface of the heat radiating member facing a bottom surface of the submount. Further preferably, the groove is not formed immediately below a center of the light emitting element. Further preferably, the submount is formed by silicon carbide or aluminum nitride. Further preferably, depth of the groove is equal in size to thickness of the light emitting element or to thickness of the submount. It may be also preferable that coefficient of thermal expansion of the submount ranges from 4×10⁻⁶/k to 6×10⁻⁶/k, that the heat radiating member is formed by copper or copper alloy, and that surfaces of the submount and the heat radiating member provided with the light emitting element are covered by a material having at least 90% of reflectivity of light.

According to the present invention, since the heat radiating member has a groove on its surface to which the submount is fixed, the heat radiating member easily deforms. With this deformation, the stress generated due to thermal expansion is absorbed or reduced, whereby peeling of the submount from the heat radiating member or damage thereof can be prevented.

As a result, the submount excellent in thermal conductivity and the heat radiating member of metal can be fixed to each other by die-bonding, and therefore a semiconductor light emitting device that is very excellent in heat radiating performance can be formed. The submount also has an advantage that an insulating material can be used, and that a circuit pattern can be created by metallizing the surface to implement simple interconnections without complicated wire bonding. Depending on the circuit pattern, it is also possible to form a plurality of light emitting elements on the submount. By forming the heat radiating member by metal, not only heat can easily be radiated to the outside of the package as the package is partially formed by metal, but workability is also improved. Thus, suitability for mass production is improved and costs can be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a semiconductor light emitting device according to a first embodiment of the present invention.

FIG. 2 is a perspective view showing a die-bonded shape of a heat radiating member, a submount, and a light emitting element included in the semiconductor light emitting device according to the embodiment of the present invention.

FIG. 3 is a cross-sectional view showing a die-bonded shape of a heat radiating member, a submount, and a light emitting element included in the semiconductor light emitting device according to the embodiment of the present invention.

FIG. 4 is a plan view of a heat radiating member included in a semiconductor light emitting device according to a second embodiment of the present invention.

FIG. 5 is a plan view of a heat radiating member included in a semiconductor light emitting device according to a third embodiment of the present invention.

FIG. 6 is a cross-sectional view showing a die-bonded shape of a heat radiating member, a submount, and a light emitting element included in a semiconductor light emitting device according to a conventional technique.

### DESCRIPTION OF THE PREFERRED EMBODIMENTS

In the following, referring to the drawings, embodiments of the present invention will be described.

### First Embodiment

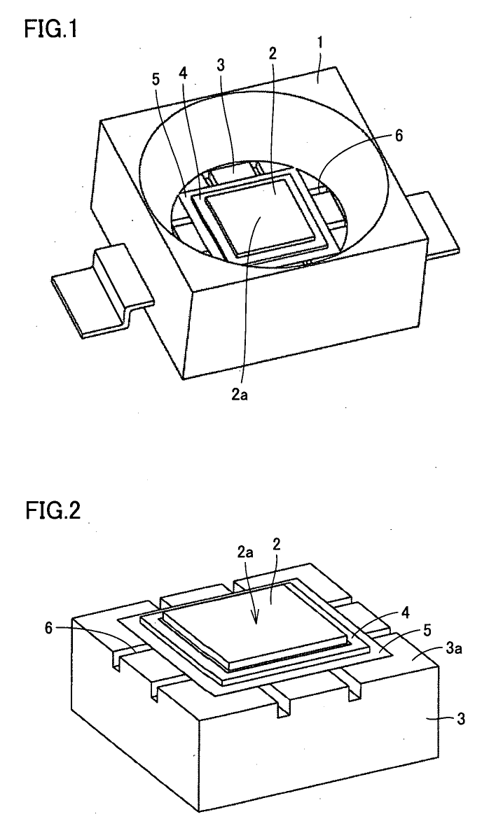

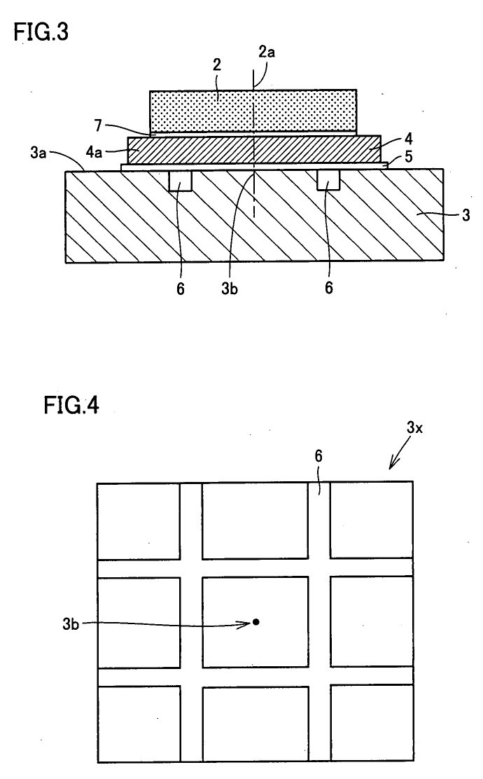

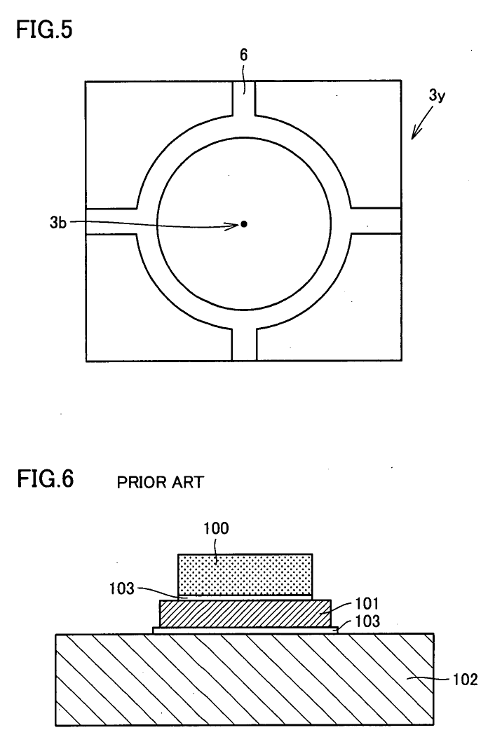

FIG. 1 is a perspective view showing a semiconductor light emitting device according to a first embodiment of the present invention. FIGS. 2 and 3 are perspective and cross-sectional views, respectively, showing a die-bonded shape of a heat radiating member, a submount, a light emitting element, and a brazing material portion included in the semiconductor light emitting device according to the embodiment of the present invention.

In the semiconductor light emitting device according to the present embodiment, a light emitting element 2 is fixed to a heat radiating member 3, within a resin package portion 1, by a brazing material 5 with a submount 4 interposed therebetween. On a surface 3a of heat radiating member 3 to which submount 4 is fixed, a groove 6 is formed. That is, on surface 3a of heat radiating member 3 on the die-bond side, groove 6 is formed. Submount 4 is die-bonded on surface 3a, using brazing material 5 such as solder or silver paste. On submount 4, light emitting element 2 is die-bonded using brazing material 7 such as gold-tin alloy (AuSn) or solder.

The surface of submount 4 is metallized by deposition of metal or the like. This allows the surface of submount 4 to conform and adhere to brazing materials 5 and 7. The metallization also allows an electrode for interconnection patterning or wire bonding or an electrode of a flip-chip to be easily formed on the surface of submount 4. Depending on the pattern of the interconnection, it is possible to mount a plurality of light emitting elements on one submount 4. Aluminum nitride (AlN), silicon carbide (SiC) or the like having high thermal conductivity and having coefficient of thermal expansion similar to that of light emitting element 2 is employed as the material of submount 4.

Since heat radiating member 3 is made of metal such as copper (Cu) or copper alloy, for example, its coefficient of thermal expansion is about 17×10⁻⁶/k, which is extremely great relative to that of SiC, i.e., 4.7×10⁻⁶/k, and that of AlN, i.e., 5.0×10⁻⁶/k. Accordingly, a thermal stress due to the difference in the thermal expansion between submount 4 and heat radiating member 3 is generated. When the material of light emitting element 2 is gallium nitride (GaN), coefficient of thermal expansion is about 5.6×10⁻⁶/k. Therefore, a thermal stress generated due to the difference in coefficient of thermal expansion between light emitting element 2 and submount 4 is small.

In order to reduce the thermal stress between heat radiating member 3 and submount 4, groove 6 is formed at the surface of heat radiating member 3. The thermal stress due to the difference in coefficient of thermal expansion is reduced by deformation of the portion surrounding groove 6. On the other hand, formation of groove 6 reduces the contacting area of submount 4 and heat radiating member 3. By the reduced amount, the thermal conductivity between them is impaired. As the temperature of a central portion 2a of light emitting element 2 is increased in particular, formation of groove 6 at a portion 3b immediately below there is avoided, so that great impairment in the thermal conductivity performance can be prevented.

### Second Embodiment

Next, a second embodiment of the present invention will be described. Groove 6 can be arranged with considerably great degree of freedom, so long as it is not formed immediately below the heat radiating portion or immediately below the center of the light emitting element. Accordingly, in the second embodiment of the present invention, as shown in FIG. 4, at the surface of heat radiating member 3x, groove 6 is formed as lines perpendicularly crossing each other at right angles, so as to surround a rectangular plane region that includes portion 3b immediately below the center of light emitting element 2.

In the plan region occupied by light emitting element 2, it is desirable that the region surrounded by groove 6 is divided to be about 1 mm² at most. If brazing materials 5 and 7 rise along light emitting element 2 or submount 4 and adhere to the sides, interfacial debonding or crack is likely to occur. Therefore, the amount of brazing materials 5 and 7 must be appropriately set. Here, when groove 6 is formed on a die-bond surface as in the present embodiment, redundant brazing material 5 is accumulated in groove 6. Thus, the rise of brazing material 5 can also be prevented.

### Third Embodiment

Next, a third embodiment of the present invention will be described in the following. In the third embodiment, as shown in FIG. 5, groove 6 is formed not at a plan region of heat radiating member 3y and portion 3b immediately below the center of light emitting element 2, but to surround a circular plan region that includes portion 3b immediately below the center of light emitting element 2. In the present embodiment also, groove 6 is formed on the die-bond surface so that brazing material 5 does not rise along light emitting element 2 or submount 4 and adhere to the sides. Therefore, redundant brazing material 5 accumulates in groove 6 and the rise thereof can be prevented.

As described above, in any of the embodiments, basically heat radiating member 3, 3x and 3y below submount 4 region is divided by groove 6. Thus, the stress due to the difference in thermal expansion between each member is reduced. It should be noted that it is often the peripheral portion of submount 4 where the greatest stress is generated to damage submount 4. Therefore, in order to reduce the stress in that portion, in some cases it is preferable that peripheral portion 4a of submount 4 is extended over groove 6 to be floated (a free end). On the other hand, in some cases such a configuration may hinder assembling of the actual product. In summary, it is only necessary that the arrangement of groove 6 is designed appropriate so that stress is reduced by groove 6.

It may also be possible to employ SiC, ceramic or the like as the material of submount 4 and to employ metal such as copper, copper alloy or the like as the material of the heat radiating member. However, the reflectivity of light of those materials is not enough as to visible light and blue-violet light having shorter wavelength than that of visible light. Accordingly, it is preferable to set the reflectivity of such light to at least 90% by coating materials having high reflectivity such as silver (Ag), nickel, palladium or the like on the surface of submount 4 and heat radiating member 3 through plating, deposition or the like. This allows light emitted from light emitting element 2 to be reflected at submount 4 and heat radiating member 3 and to go out along the optical axis direction on the upper surface of light emitting element 2. This achieves the effect that the amount of light in the optical axis direction is increased.

As described above, the semiconductor light emitting device in each embodiment above can obtain the structure being excellent in both heat radiation performance and reliability. The manufacturing workability is also excellent, and therefore it is suitable for mass production. Accordingly, the semiconductor light emitting device can be used in an illumination apparatus in which a light emitting element of high output is employed or can be used as a light source of a projector.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A semiconductor light emitting device, comprising:
a light emitting element;
a heat radiating member; and
a submount interposed between said light emitting element and said heat radiating member, wherein
said light emitting element is fixed to said heat radiating member by a brazing material with said submount interposed, and
said heat radiating member has a groove on its surface to which said submount is fixed.

2. The semiconductor light emitting device according to claim 1, wherein
said groove is provided at least at a surface of said heat radiating member facing a bottom surface of said submount.

3. The semiconductor light emitting device according to claim 1, wherein
a groove is not formed immediately below a center of said light emitting element.

4. The semiconductor light emitting device according to claim 1, wherein
said submount is formed by silicon carbide.

5. The semiconductor light emitting device according to claim 1, wherein
said submount is formed by aluminum nitride.

6. The semiconductor light emitting device according to claim 1, wherein
depth of said groove is equal in size to thickness of said light emitting element.

7. The semiconductor light emitting device according to claim 1, wherein
depth of said groove is equal in size to thickness of said submount.

8. The semiconductor light emitting device according to claim 1, wherein
coefficient of thermal expansion of said submount ranges from 4×10⁻⁶/k to 6×10⁻⁶/k.

9. The semiconductor light emitting device according to claim 1, wherein
said heat radiating member is formed by copper or copper alloy.

10. The semiconductor light emitting device according to claim 1, wherein
surfaces of said submount and said heat radiating member provided with said light emitting element are covered by a material having at least 90% of reflectivity of light.
